(19) United States
(12) Patent Application Publication
(10) Pub. No.: US 2009/0241642 A1
(43) Pub. Date: Oct. 1, 2009

(54) Method for Determination of a Leakage on a Piston Machine

(76) Inventor: Age Kyllingstad, Algard (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/912,103

(22) PCT Filed: Apr. 10, 2006
(86) PCT No.: PCT/NO2006/000131

§ 371 Date: May 15, 2008

(30) Foreign Application Priority Data
Apr. 20, 2005 (NO) 20051916

(51) Int. Cl. G01M 3/28

(52) U.S. Cl. 73/40

(57) ABSTRACT

A method of determining a leakage in a piston machine comprising at least two pistons is provided. The rotational velocity of the piston machine, and therefore the volume flow through the piston machine, is varied periodically as part of a time-limited active test while measuring the differential pressure and the angular position. An angular position-based Fourier analysis of the measured values from differential pressure and rotational velocity measurements performed during the test are used to experimentally determine the amplitude ratio and phase angle difference between volume flow variations and pressure variations. The amplitude ratio and phase angle difference are used, together with an angular position-based Fourier analysis of the measurements of differential pressure and rotational speed made after the active test, to determine the amplitude and phase of the leakage flow.

This invention regards a method of determining a leakage in a piston machine. More particularly, it concerns a method of, among other things, quantifying and/or locating a leakage in a piston machine. In this context, piston machine is taken to mean all types of pumps and hydraulic motors that are provided with a rotating crankshaft or cam, where the crankshaft or cam drives or is driven by at least two pistons in a controlled reciprocating motion, and where each piston cylinder is provided with at least two valves arranged to rectify the direction of flow through the engine. The invention also comprises a device for implementing the method.

When operating piston machines it is vital, for reasons of safety and economics, that leakages in e.g. piston packings and valves are detected at an early stage. Leaks of this type are acceleratory, and when they become large enough for the operator of the piston machine to detect them through large abnormal pressure variations, the piston machine must often be shut down and overhauled immediately, leaving no option of postponing the maintenance work to a later and operationally more suitable time.

It is also a great advantage to be able to quantify the leakage in order to determine how rapidly it is developing, and in order to estimate how long it will be before the defective component must be replaced. Furthermore, it is an advantage to be as certain as possible of where the piston machine is leaking, so as to allow the defective component to be replaced quickly without having to spend time searching for it.

Several methods of detecting leakages in piston machines are known. U.S. Pat. No. 5,720,598 concerns a method in which a fault in the pumps is detected by monitoring certain harmonic frequency components of the measured discharge pressure. The method makes direct use of the harmonic amplitudes and the phase of the pressure signal, without correcting for frequency dependent distortions of amplitude and phase that unavoidably result from the typical downstream geometry. For instance, the effect of a pulsation dampener and reflected pressure waves in the discharge pipe may result in phase errors of a magnitude large enough to render the localization method of U.S. Pat. No. 5,720,598 useless.

Publication WO 03/087754 further discloses a method for early detection and localization of leakages in piston machines. This method makes use of a Fourier analysis based on angular positions, but the transformation from pressure variations to volumetric flow variations is theoretically determined. This can represent a significant source of errors during the analysis.

The object of the invention is to detect an incipient leakage at an early stage and preferably also quantity the leakage, whereby repairs may be scheduled for a later date. Advantageously the leakage can be located, so as to allow repairs to be carried out quickly.

It is also a principal aim of the invention that the leakage detection be performed on the basis of pressure measurements and measurements of angular position, and without using flow measurements, as these are either inaccurate or very costly to perform, and as such unsuitable for the purpose.

The object is achieved in accordance with the invention, by the features indicated in the description below and in the following claims.

The method of determining a leakage in a piston machine comprising at least two pistons includes the following steps:
periodically varying the rotational velocity of the piston machine, and thus the flow rate, as part of a time-limited active test while measuring differential pressure and angular position;
using an angular position-based Fourier-analysis of the measurements of differential pressure and rotational velocity, performed during said test, to experimentally determine the amplitude ratio and phase angle difference between the volumetric flow variations and pressure variations; and
using said amplitude ratio and phase angle difference, together with an angular position-based Fourier analysis of the measurements of differential pressure and rotational speed made after the active test, to determine the amplitude and phase of the leakage flow.

Advantageously the leakage is quantified in terms of the size of the leakage area by using the amplitude of said leakage flow together with the mean differential pressure, geometrical factors and the Bernoulli Equation of the conservation of energy.

It is furthermore possible to locate the source of the leakage by means of the phase of said leakage flow.

Advantageously the method is applied in order to determine leakages in each of several asynchronously rotating piston machines tied in to a common outlet or inlet pipe, the method including the steps of:
periodically varying the rotational velocity of the piston machine, and thus the flow rate, of each piston machine as part of a time-limited active test while measuring differential pressures and angular positions for each piston machine;
using an angular position-based Fourier-analysis of the measurements of differential pressures and rotational velocities, carried out during said test, in order to experimentally determine the amplitude ratios and phase angle differences between the volumetric flow variations and pressure variations for each piston machine; and
using said amplitude ratios and phase angle differences, together with an angular position-based Fourier analysis of the measurements of differential pressures and rotational velocities made after the active test, to determine the amplitude and phase of the leakage flow for each piston machine.

The leakage may also, when several piston machines work together, be quantified in terms of the size of the leakage area. This is done by using the amplitude of said leakage flow together with the mean differential pressure, geometrical factors and the Bernoulli Equation of the conservation of energy.

Furthermore it possible, also when several piston machines work together, to locate the source of the leakage by means of the phase of said leakage flow.

Ideally, the volume flow and pressure into and out of the piston machine should be as steady as possible, but in practice these quantities will fluctuate with the rotational velocity of the piston machine. Such fluctuations are primarily caused by

(a) geometric factors that cause the sum of the piston velocities in each phase to be non-constant,
(b) the compressibility of the fluid, which makes it necessary to compress and then decompress the fluid prior to equalising the pressure and opening the respective valves,
(c) valve inertia that cause further delays in the opening and closing of valves, and
(d) a flow-dependent pressure drop through valves and feed passages.

If all pistons and valves are identical and operate normally, the fluctuations will as a result of symmetry have a fundamental frequency equal to the rotational frequency of the piston machine multiplied by the number of pistons in the machine. However, if an abnormal leak were to occur in e.g. one of the pistons or one of the valves, the symmetry would be broken and both the flow and the pressure would have new frequency components, with the lowest frequency equal to the rotational frequency of the piston machine.

The following description is based on a single piston machine to explain the method. Later an explanation is given of how the method can easily be generalised so as also to include a plurality of piston machines tied in to a common inlet and/or outlet pipe.

The relationship between volumetric flow and differential pressure in a piston machine is generally complex and depends on numerous parameters.

The differential pressure, in the following generally termed pressure for the sake of simplicity, is here defined as the outlet pressure minus the inlet pressure, and is normally positive for pumps and negative for engines.

Among the most important parameters is the piping geometry of a circulation loop connected to the piston machine, i.e. length, the internal diameter and dimension of restrictions (nozzles), the volume and charging pressure of any gas accumulator, and the density and viscosity of the liquid. It is difficult, even with a detailed knowledge of these factors, theoretically to determine this relationship with a sufficient degree of accuracy. However, it is possible to determine this relationship experimentally.

If, for the time being, any external pressure variations caused by variable restrictions in the circulation loop are ignored, the pressure variations are related to flow variations into and out of the piston machine. If the rotational velocity of the piston machine is approximately constant, the flow (out of a pump, into an engine) may be expressed as a periodic function represented by the following series:

$$q = \overline{q} + {\sum }_{k = 1}^{∞} {q}_{k} cos ( k θ - {α}_{k} ) \qquad ( 1 )$$

where θ equals the angular position of the piston machine shaft, in radians, q̅ equals the average flow rate of the piston machine, and qₖ and αₖ are the amplitude and phase, respectively, of harmonic component no. k. The angular velocity (hereinafter termed rotational velocity or just velocity) is the time derivative of the angular position:

$$ω = \frac{d θ}{d t} \qquad ( 2 )$$

and so can be found without performing a separate measurement.

The angular position θ of the rotating crankshaft or cam of the piston machine is measured directly or indirectly and normalised to values of between 0 and 2π, optionally between −π and π radians, where 0 represents the start of the power stroke of piston no. 1. The piston machine comprises two or more pistons uniformly distributed, so that piston no. j of a total of n pistons has a phase lag (angle) of (j−1) 2π/n with respect to the first piston.

The periodic flow variations are related to pressure variations, which may similarly be expressed as:

$$p = \overline{p} + {\sum }_{k = 1}^{∞} {p}_{k} cos ( k θ - {β}_{k} ) \qquad ( 3 )$$

where pₖ and βₖ are the amplitude and phase, respectively, of harmonic component nr. k.

In the following, the fluctuations are assumed to be relatively small, i.e. qₖ<< q̅ and pₖ<< p̅ for all k. This allows linear theory to be applied to the deviations from the mean values.

The relationship between the mean values may still be non-linear, so that the mean differential pressure may be a more or less complex function of the mean flow or vice versa, i.e. p̅=ƒ( q̅) or q̅=g( p̅).

Using complex notation allows the mathematical presentation to be simplified as much as possible. Thus, the amplitude qₖ and the phase angle αₖ can be represented by a complex amplitude Qₖ by qₖ cos(kθ−αₖ)=Re{Qₖe^{-ikθ} }, where i=√−1 is the imaginary number. Thus the complex amplitude represents both a real amplitude, by qₖ=|Qₖ|, and a phase angle, by αₖ=arg(Qₖ). Corresponding complex amplitudes can also be defined for pressure and velocity: pₖ cos(kθ−βₖ)=Re{Pₖe^{-ikθ}}, ωₖ cos(kθ−γₖ)=Re{Ωₖe^{-ikθ}}. In the following, lower-case letters are consistently used for real quantities, while upper-case letters are used for complex amplitudes.

It is well known to a person skilled in the art that a periodic signal can be split up into so-called harmonic components by means of e.g. Fourier analysis. Thus the k^{th} harmonic component of e.g. the pressure can be represented by a complex coefficient defined by the following integral:

$$\begin{matrix}{P}_{k} = \frac{1}{π} {\int }_{0}^{2 π} p {e}^{i k θ} d θ \\ = \frac{1}{π} {\int }_{0}^{2 π} p cos ( k θ ) d θ + \frac{i}{π} {\int }_{0}^{2 π} p sin ( k θ ) d θ\end{matrix} \qquad ( 4 )$$

Corresponding coefficients can also be defined for volume flow and rotational velocity, without being shown explicitly here.

The integrals, which in practice must be implemented as summations in a computer or in a programmable logic controller (PLC), are updated for each new revolution of the piston machine. The integrals can be continuously updated for each new measurement of pressure and angular position, or alternatively the measured values can be stored in a temporary register for calculation upon each completed revolution.

The method of finding complex amplitudes, exemplified by equation (4), can be called an angular position-based Fourier analysis. It differs from the normal Fourier analysis in that the integrals are not based on time but on measured angular positions. One of the advantages of this is that the phase of the complex amplitudes can be tied directly to the angular position of the shaft or cam. Another advantage is that the method allows the time intervals between the measuring points to vary, as they typically do in a PLC. However, the measuring frequency should be high enough to ensure that a revolution includes numerous measuring points, even at the highest rotational velocity. A third advantage is that the method is more robust with respect to periodic and aperiodic variations in the rotational velocity. Unlike a time-based Fourier analysis, which will yield frequency spectra having side components in addition to the harmonic components, an angular position-based Fourier analysis will yield pure harmonic components.

In order to improve the accuracy of the complex amplitude and minimize the effect of slow changes in the mean value, one can with advantage make use of dynamic values and make corrections for the measured rate of change of the mean value. As an example, the pressure p in the integral for the complex pressure amplitude may be substituted by \tilde{p}=p− p̅− p̅′θ, where p̅ is the mean pressure value found through the integral

$$\overline{p} = \frac{1}{2 π} {\int }_{0}^{2 π} p d θ \qquad ( 5 )$$

and p̅′ is the rate of change (change in pressure per radian) found from e.g. the change in p̅ measured over the last two revolutions.

To effectively suppress stochastic noise and aperiodic variations in the quantities measured one can also take the average of the coefficients over several periods, or optionally use a recursive smoothing filter.

As a result of the assumption of small fluctuations and linearity the relationship between fluctuations in volume flow and pressure may be represented by the following complex equation

Pₖ=HₖQₖ (6)

where Hₖ is a complex frequency dependent transfer function for component k. The challenge is to find Hₖ such that the volume flow Qₖ=Pₖ/Hₖ can be calculated after Pₖ has been found.

The following concerns the harmonic components of the lowest order, those that have an amplitude of zero under conditions of no leakage. (Although the fundamental harmonic k=1 is normally the most suitable component, the example is made as general as possible by keeping k as an unspecified harmonic index.) The complex amplitude of volume flow component k can then be written as a sum of a leakage flow and a volume flow variation due to a variation in the rotational velocity of the piston machine. The latter may be impressed, originating from a control signal via a speed regulator, or it may be a result of cyclic loading due to the leakage or a controlled mechanical load variation. In both cases, the following holds:

Qₖ=Lₖ+V·Ωₖ (7)

where Lₖ is the leakage component of the volume flow, V=η·n·Vₚᵢₛₜₒₙ/(2π) is the specific volume per radian, where η is the volumetric efficiency, n is the number of pistons and Vₚᵢₛₜₒₙ is the volumetric displacement per piston, and Ωₖ is the complex amplitude (in rad/sec) of the variation in velocity.

If pressure and velocity coefficients can be found for two states having the same mean velocity and pressure but different velocity variations Ωₖ⁽¹⁾ and Ωₖ⁽²⁾, equations (6) and (7) may be combined, so that

Pₖ⁽²⁾−Pₖ⁽¹⁾=Hₖ(Qₖ⁽²⁾−Qₖ⁽¹⁾)=HₖV(Ωₖ⁽²⁾−Ωₖ⁽¹⁾) (8)

Here, the leakage flow is assumed to be the same in both cases, i.e. Lₖ⁽²⁾=Lₖ⁽¹⁾. The above equation gives the following expression for the transfer function:

$${H}_{k} = \frac{{P}_{k}^{( 2 )} - {P}_{k}^{( 1 )}}{V ( {Ω}_{k}^{( 2 )} - {Ω}_{k}^{( 1 )} )} \qquad ( 9 )$$

This formula represents an empirically determined transfer function because V is known and all the complex coefficients in the numerator and denominator have been found on the basis of a Fourier analysis of measured values of pressure and rotational velocity.

It is important to note that this transfer function, consisting as it does of a numerical real part and a numerical imaginary part, is valid only for a given frequency (equal to k· ω̅/2π) and for the mean pressure p̅ in question.

For that reason, Hₖ must be determined anew every time p̅ and/or ω̅ changes significantly.

One of the two states may be a normal state in which the rotational velocity is kept as constant as possible. The other must be a state in which the piston machine is subjected to a cyclic variation in velocity. For a velocity regulated pump the desired velocity may be given by e.g.:

ωₛₑₜ= ω̅+ωₖ sin(kθ) (10)

Although the velocity regulator is not ideal and there is a difference between the desired and actual rotational velocity, this is of no consequence as long as the difference in measured velocity amplitude, |Ωₖ⁽²⁾−Ωₖ⁽¹⁾|, is large enough. The speed of a piston machine may be varied more indirectly by impressing a cyclic variation of the mechanical motor load.

Measurements made with a mud pump under realistic conditions have shown that it may take quite a long time (multiple pump revolutions) from the pumping rate/velocity variation changes to the pressure and pressure variations stabilize. This is probably caused by reflected pressure waves from the end of the downstream pipe, combined with weak attenuation of the pressure waves. A result of this is that the outlined test must leave room for long transient times between the intervals used to calculate the pairs of complex coefficients (Ωₖ⁽¹⁾,Pₖ⁽¹⁾) and (Ωₖ⁽²⁾,Pₖ⁽²⁾).

Now that the transfer function Hₖ is known, the volume flow of the leakage can be determined from:

$${L}_{k} = {Q}_{k} - V \cdot {Ω}_{k} = \frac{{P}_{k}}{{H}_{k}} - V \cdot {Ω}_{k} \qquad ( 11 )$$

Said test, which hereinafter is termed an active test because it includes a component where the rotational velocity is subjected to a cyclic disturbance, may be described by the following non-limiting example of an algorithm:

I. Wait for a stabilizing period (e.g. 10 revolutions) after the last change of the mean rotational velocity.
II. Start the Fourier analysis and determine the mean value of the complex pressure and velocity coefficients (Ωₖ⁽¹⁾Pₖ⁽¹⁾) over an interval of e.g. another 10 revolutions.
III. Maintain the same mean rotational velocity while subjecting the instantaneous velocity to a cyclic variation, e.g. as described in equation (10). Wait until the new state has stabilized.
IV. Start the Fourier analysis and determine the mean value of the second set of complex pressure and velocity coefficients (Ωₖ⁽²⁾,Pₖ⁽²⁾) over an interval equal to that of the previous analysis. Determine the transfer function Hₖ by means of the above equation (10).
V. Stop the velocity variations and wait for a new stabilizing period before resuming the Fourier analysis and determining the leakage flow.

A great advantage of using an empirically determined transfer function is that the effect of using any filter such as a low-pass filter or a band-pass filter one or more places in the chain of signals from the pressure sensor to digitalized pressure, will be cancelled. This is because such a filter, which may be represented by a complex filter function F, will appear as a common factor of both numerator and denominator in the fraction that forms the first term on the right side of equation (11).

The real amplitude |Lₖ| of the leakage flow is not suited for use as a quantity indicator for the leakage, because is varies with both mean pressure and volume flow for a given leakage area. A better method is to calculate a leakage area based on the measured leakage flow, the mean pressure and Bernoulli's well known equation for conservation of energy in fluid flow:

$$Δ p = \frac{1}{2} ρ {v}^{2} \qquad ( 12 )$$

Here, Δp is the pressure difference, ρ is the density of the liquid and ν is the velocity of the liquid. With a leakage area A and a so-called discharge coefficient C, which takes the deviation from ideal flow into account (a typical value for a nozzle is C=0.7), the instantaneous volume flow through the leakage opening can be written as

$$l = vA = CA \sqrt{\frac{2 Δ p}{ρ}} \qquad ( 13 )$$

For the sake of simplicity, the differential pressure is here assumed to alternate between a constant positive value | p̅| and zero. An asymmetric cycle will here be allowed by the power stroke representing an angle ψ (For symmetrical piston machines, in which the power stroke and the return stroke are of the same duration, e.g. in all crank driven pumps, ψ=π. It can be demonstrated that the real k^{th} harmonic amplitude of the leakage flow will then be:

$$\vert {L}_{k} \vert = \frac{2 l}{π} {\int }_{0}^{ψ / 2} cos ( k θ ) d θ = \frac{2 CA sin ( ψ / 2 )}{k \cdot π} \sqrt{\frac{2 \vert \overline{p} \vert}{ρ}} \qquad ( 14 )$$

If this equation is solved with regard to the leakage area, the following expression results:

$$A = \frac{k \cdot π}{2 C sin ( ψ / 2 )} \sqrt{\frac{ρ}{2 \vert \overline{p} \vert}} \cdot \vert {L}_{k} \vert \qquad ( 15 )$$

The phase angle, λ₁=arg(L₁), of the first harmonic complex leakage flow (the index k=1 is omitted hereinafter) contains information which can be used to locate the source of the leakage, as explained below.

First, it is assumed that the inlet valve or the piston packing for piston no. 1 in a pump is leaking, resulting in an insufficient volume flow out of the pump during the pump stroke, which lasts from θ=0 to θ=ψ. The phase with a minimum discharge will then be ω/2+δ, where δ represents a small phase lag due to compressibility and time-lags in the closing of the valve. The phase of the leakage flow is where the first harmonic is at a maximum, i.e. at ψ/2+δ−π.

If, on the other hand, the outlet valve is leaking, the phase of the leakage will be shifted half a revolution, making the corresponding phase angle ψ/2+δ.

It is relatively simple to generalize for leakages in the other pistons or valves. If the pump has n pistons, the phase from inlet valve no. j is given by:

$${λ}_{j}^{in} = \frac{ψ}{2} + \frac{j - 1}{n} 2 π + δ - π \qquad ( 16 a )$$

and from outlet valve no. j:

$${λ}_{j}^{out} = \frac{ψ}{2} + \frac{j - 1}{n} 2 π + δ \qquad ( 16 b )$$

If necessary, the phase angles must be normalized. These expressions have been derived for pumps, but similar expressions can also be derived for engines. Common to both these types of piston machines is that in the case of a normal leak, which is here defined as leakage through a small but constant leakage opening, the 2n different inlet and outlet valves will give 2n phase angles on the estimated leakage flow L. If the number n of pistons is an odd number, all the leakage angles are different, and it is possible to make a precise determination of the source of the leakage, except that it is not possible to differentiate between a leakage in the piston and a leakage in the inlet valve. If, on the other hand, n is an even number, the localization is ambiguous. The reason for this is that a leakage in an inlet valve no. j will have the same phase angle as a leakage in the complementary outlet valve j±n/2, which is displaced by 180 degrees relative to no. j.

The method of quantification and localization of a leakage can be summed up in the following brief algorithm.

i. Angular position-based integrals are used to determine the mean value and complex amplitudes of the measured pressure and rotational velocity for each completed revolution of the piston machine.
ii. A new value of the transfer function H is found after each change in the mean rotational velocity and/or pressure, by means of an active test such as described by the algorithm below equation (11).
iii. After the test has been completed, the complex volume flow amplitude of the leakage is found by means of the above formula (11).
iv. The effective aperture area of the leakage is determined through use of the above formula (14).
v. Possible sources of the leakage are determined by comparing the phase angle of the leakage flow with tabulated values for leakages in the various pistons and valves of the piston machine. If required, corrections are made for compression delays and valve delays.

The method of the invention represents significant improvements on prior art, particularly with respect to quantification and localization of leakages. According to the invention, the angular position of the machine shaft is measured and used directly in the harmonic analysis without using the normal time-based frequency analysis such as is known from U.S. Pat. No. 5,720,598. Another important difference is that, according to the invention, the method employs active tests to determine the amplitude ratio and phase angle difference between volume flow variations and pressure variations, and that these measured quantities are used together with the variation in velocity to calculate the amplitude and phase of the leakage flow. The method of U.S. Pat. No. 5,720,598 makes direct use of the harmonic amplitudes and the phase of the pressure signal, without making corrections for the frequency-dependent distortions of amplitude and phase that unavoidably result from the downstream geometry. For instance, the effect of a pulsation dampener and pressure wave reflections in the discharge pipe may result in phase errors of a magnitude large enough to render the localization method of U.S. Pat. No. 5,720,598 useless. The method of the invention for both quantification and localization has novelty.

The method that forms the subject of the invention entails a considerable simplification, compared with WO 03/087754, of the transformation from pressure variations to volume flow variations, which according to WO 03/087754 is theoretically determined and is neither as simple nor as accurate as the method of the invention, where the transformation is determined by active tests. Consequently, the invention differs significantly from prior art in this field.

The above described method can also be used when several piston machines are connected to the same inlet and/or outlet and rotate at different velocities.

The magnitude and the location of the leakage can be found separately for each piston machine, provided the differential pressure and angular position are measured for each piston machine.

As the pressure variations on the low pressure side of the piston machines are normally quite small, it will often be sufficient, in those cases where the piston machines are interconnected at the high pressure side only, to measure one common pressure instead of individual differential pressures.

Independent leakage determinations are made possible because the angular position-based Fourier analysis combined with smoothing of the complex pressure variation coefficients acts as a sharp band-pass filter that eliminates the effect of non-harmonic frequencies. The smaller the difference in mean rotational velocity, the heavier the smoothing must be to prevent leakage components from a piston machine from causing interference and errors in the determination of a leakage in another piston machine.

If two or more piston machines are rotated synchronously, i.e. at the same mean velocity, it will not be possible to determine the leakage from these machines separately. The method will still be applicable for detection and quantification of any leakage, but in order to determine the source of the leakage the piston machines must rotate asynchronously.

In the following there is described a non-limiting example of use of the method illustrated in the accompanying drawings, in which:

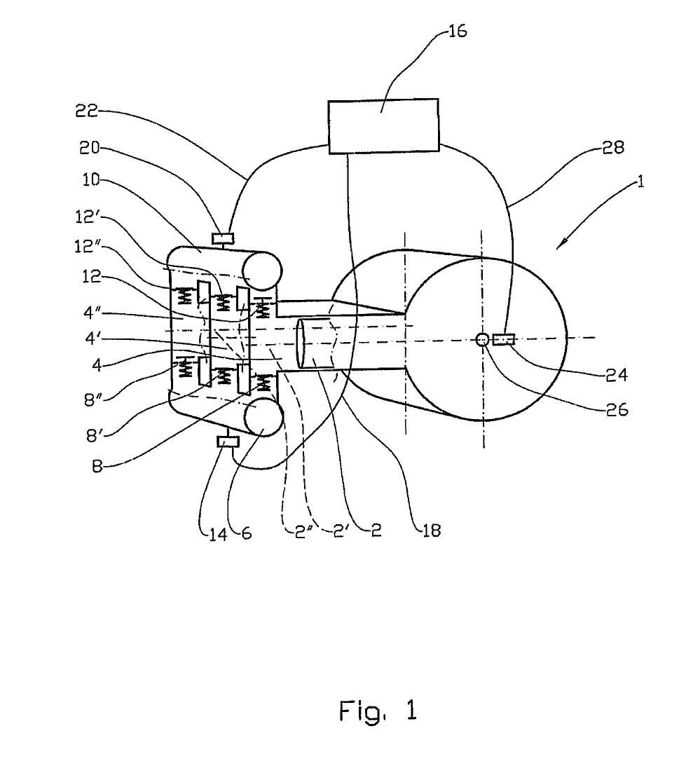

FIG. 1 schematically shows a triplex pump equipped with the required measuring devices and analyzers;

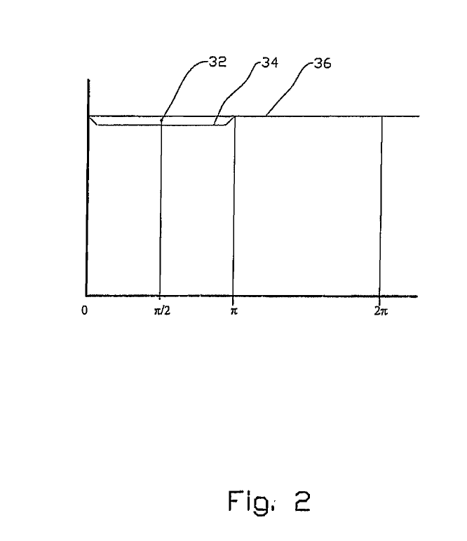

FIG. 2 shows a curve illustrating the delivered volume flow as a function of the rotational angle of the pump, showing a central point of area representing a leakage volume of a piston leak; and

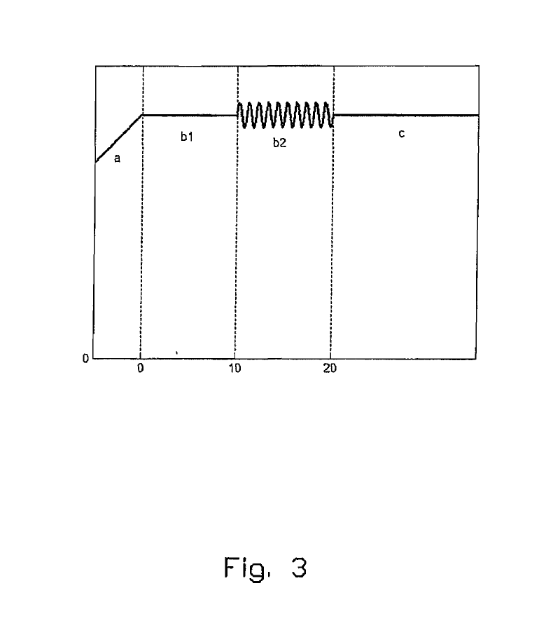

FIG. 3 shows a curve representing the rotational velocity as a function of the revolutions of the piston machine before, during and after an active test.

In the drawings, reference number 1 denotes a so-called triplex pump provided with three individually acting pistons 2, 2′ and 2″, respectively, extending through their respective cylinders 4, 4′ and 4″. The cylinders 4, 4′ and 4″ communicate with an inlet manifold 6 through their respective inlet valves 8, 8′ and 8″, and an outlet manifold 10 through their respective outlet valves 12, 12′ and 12″, respectively. An inlet pressure sensor 14 is connected to the inlet manifold 6, communicating with a computer 16 via a line 18, and an outlet pressure sensor 20 is connected to the outlet manifold 10, communicating with the computer 16 via a line 22. A rotational angle transmitter 24 is arranged to measure the rotational angle of the crankshaft 26 of the pump 1, and is communicatingly connected to the computer 16 by means of a line 28. The sensors 14 and 20, the transmitter 24 and the computer 16 are of types that are known per se, and the computer is programmed to carry out the calculations in question.

In the event of a leak in the packing of the first piston 2, the discharge through the outlet valve 12 during the pumping phase will be reduced by a quantity equal to the leakage flow past the piston 2. As the pump stroke extends over half a revolution of the crankshaft 26 of the pump 1, the central point 32, see FIG. 2, for this reduction in volume flow is approximately π/2 radians (90°) after the start of the pump stroke. In FIG. 2, the curve 34 indicates the reduction in the average volume flow 36 which occurs as a result of the piston leakage. In reality, the central point 32 of area representing the leakage volume will lag an additional, small angle behind the centre angle of the pump stroke. This is due to delays caused by the inertia of the valves and the compressibility of the liquid. These effects can be calculated and corrected for by adding a pressure and velocity dependent phase delay δ.

FIG. 3 shows the end of an interval a of velocity increase, then the two main parts of a test b1 and b2, the latter being the active part in which the velocity variation is cyclic, in this case at a frequency equal to the rotational frequency of the piston machine 1. The last interval c represents the start of the interval in which the transfer function H is determined and any leakage can be quantified and located.

1. A method of determining a leakage in a piston machine comprising at least two pistons, characterized in that
the rotational velocity of the piston machine, and therefore the volume flow through the piston machine, is varied periodically as part of a time-limited active test while measuring the differential pressure and the angular position;
an angular position-based Fourier analysis of the measured values from differential pressure and rotational velocity measurements performed during said test are used to experimentally determine the amplitude ratio and phase angle difference between volume flow variations and pressure variations; and
said amplitude ratio and phase angle difference are used, together with an angular position-based Fourier analysis of the measurements of differential pressure and rotational speed made after the active test, to determine the amplitude and phase of the leakage flow.

2. A method in accordance with claim 1, characterized in that the leakage is quantified in terms of the size of the leakage area, by using the amplitude of said leakage flow together with the mean differential pressure, geometrical factors and Bernoulli's Equation of the conservation of energy.

3. A method in accordance with claim 2, characterized in that the phase of said leakage flow is used to locate the source of the leakage.

4. A method in accordance with claim 1 for determining leakages in each of several asynchronously rotating piston machines connected to a joint outlet and/or inlet pipe, characterized in that
the rotational velocities of the piston machines, and with this the volume flow through each piston machine, are varied periodically as part of a time-limited active test while measuring the differential pressure and angular position for each piston machine;
an angular position-based Fourier analysis of the measured values from differential pressure and rotational velocity measurements performed during said test are used to experimentally determine the amplitude ratio and phase angle difference between volume flow variations and pressure variations for each piston machines; and
said amplitude ratios and phase angle differences are used, together with an angular position-based Fourier analysis of the measurements of differential pressures and rotational speeds made after the active test, to determine the amplitude and phase of the leakage flow for each piston machine.

5. A method in accordance with claim 4, characterized in that the leakages are quantified in terms of the size of the leakage area for each piston machine, by using the amplitudes of said leakage flows together with the mean differential pressures, geometrical factors and Bernoulli's Equation of the conservation of energy.

6. A method in accordance with claim 5, characterized in that the phases of said leakage flows are used to locate the source of the leakage for each piston machine.
